(19) United States
(12) Patent Application Publication
(10) Pub. No.: US 2015/0016117 A1
(43) Pub. Date: Jan. 15, 2015

(54) Wide-angle Light Emitting Diode Bulb

(71) Applicant: Kenner Material & System Co., Ltd., Jhongli City (TW)

(72) Inventors: Cheng-Che Tsai, Jhongli City (TW); Tsung-Mo Hsu, Jhongli City (TW); Chin-Huei YEN, Jhongli City (TW)

(21) Appl. No.: 14/327,656

(22) Filed: Jul. 10, 2014

(30) Foreign Application Priority Data
Jul. 10, 2013 (TW) 102213266

(51) Int. Cl. F21K 99/00

(52) U.S. Cl. CPC F21K 9/54; F21K 9/135; F21Y 2111/005
USPC 362/307

(57) ABSTRACT

A wide-angle light emitting diode bulb comprises a LED chip module, a LED driver component for provide power, and a lamp cup for housing the LED chip module and the LED driver component. Main portion of light emitted from the LED chip is through the lamp cover out but a portion of LED light is scatted by the diffused powder on the lamp cover and through the apertures at the lamp cup out to light the ceiling when the LED bulb lit. The diffused powders are in-situ doped during manufacturing the lamp cover. The apertures are hided at the cabin-shaped recesses of the lamp cup.

### CROSS-REFERENCE TO RELATED APPLICATION

The application claims the benefit of a TAIWAN Patent Application Serial Number 102213266, filed on Jul. 10, 2013, which is herein incorporated by reference in its integrity.

### TECHNICAL FIELD

The present invention pertains to a light emitting diode (LED) bulb device, particularly, to a LED bulb having a flat base inside, with wide-angle light emitting effect.

### BACKGROUND OF RELATED ART

In the oil electric double up today, with high power consumption, shorter operated time or say the lifetime, as the traditional incandescent bulb is, it increases the indoor temperature too. Therefore, governments have been progressively banned use and the production of incandescent bulbs since 2010 and replaced them by energy saving bulbs because the energy saving bulbs provides same lumens, but use only about 1/4 power.

Nowadays, LED bulbs are found more favorite over the energy-saving bulbs. The advantages include more energy saving and longer durable and operated longer (30,000 hours or above), mercury free, and no UV. Therefore, the LED bulbs are high hopes and become synonymous of energy saving and environmental friendly too.

LED chip is known as high directivity as a point source. When a conventional LED bulb installed in the E27 lamp socket lighting, there is no ceiling light. A LED bulb is generally called as half omnidirectional LED bulb since it has angles in a range between about 120°-180°. For many users accustomed using incandescent bulbs or energy saving bulbs may feel something weird for the illuminated area.

Thus, recently, there have been many omnidirectional LED bulbs sold in the appliance lighting market. The LED bulbs have angles between about 180 degrees to 360 degrees. They can make the ceiling certain brightness. The illuminating angle of the LED is comparable to incandescent bulbs or energy saving light bulbs. Thus, the omnidirectional LED bulbs are found more popular than the otherwise.

To overcome the high directivity and approach the purpose of omnidirection, the conventional omnidirectional LED bulbs usually assembled two or three LED substrates to become 3-D modeling. An example is shown in Taiwan Patent Publication No. 200,708,684, as seen FIG. 1 and FIG. 2, which show a LED bulb containing a global cover 11 and having an extending hollow 111 to mount on the lamp head 12. An isometric triangle heat dissipation prism 13 installed in the lamp head 12 and stood into the cover 11 through the hollow 111. The heat dissipation prism 13 has three embedded grooves 131 at the three surfaces of it for light emitting units 14 inserted thereon. Each light emitting unit 14 includes a circuit board 141 having LED array mounted on it or called a LED submount. By means of three light emitting units, emitting light rays outward in various directions, the LED bulb is thus called omnidirection.

Another conventional technique may refer to the Taiwan patent No. M412319. The feature is shown in the FIG. 3. The LED bulb includes a global cover 11, lamp head 3, a sphere modeling pedestal 5 and a light emitting unit. The cover 11 is formed of glass or plastic. The lamp head 3 is engaged with the neck of the global cover 11. The lamp head 3 has a thread for screwing on a lamp socket (not shown). The lamp socket may set at ceiling, table lamp, floor lamp etc., or any lighting appliance. The modeling pedestal 5 of the light emitting unit having LED chips 54 mounted on the surface of a modeling pedestal 5, which is a hollow sphere 53 The modeling pedestal 5 burdened the heat dissipation is installed in the lamp head and extended up the housing space of the cover 11.

The LED bulb in accordance with the second embodiment may provide omnidirection effect more than that of the first embodiment. Nevertheless, the modeling pedestal 5 may increase the cost and have worse heat dissipation capability.

### SUMMARY

A wide-angle light emitting diode (LED) bulb comprises a lamp head, a lamp cup housing a LED pedestal with one LED submount thereon, and a LED driver components and a half global cover. The lamp cup is modeled with a plurality of cabin-shaped recesses formed around a circumference surface of the lamp cup to increase heat sink area. Each recess has an aperture formed therein for backward light emitting by said LED submount passed therethrough. The half global cover engaged with an edging of a first ending of the lamp cup. The lamp head engages with an edging of a second ending of the lamp cup for screwing with a socket.

The backward light is a scattered LED light scattered by diffused powders on the bulb cover and the high reflectivity lamp cup. The backward light is occupied between about 1.7˜2% of total lumens of LED light for a beam angle larger than 135° or between about 9.9%˜10.2% for a beam angle larger than 90°, which is almost two times of lumen in comparison with a LED bulb without an aperture.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates an exploded diagram of an omnidirectional LED bulb according to an embodiment of the prior art.

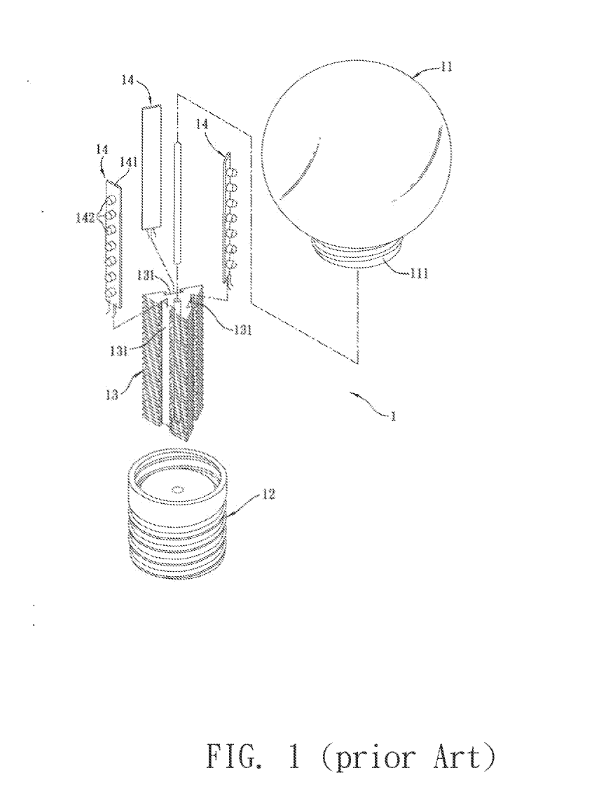

FIG. 2 illustrates a wide-angle LED bulb according to the embodiment of the prior art.

FIG. 3 illustrates a wide-angle LED bulb according to the other embodiment of the prior art.

FIG. 4 illustrates a schematic diagram of a wide-angle LED bulb according to the present invention.

FIG. 5 illustrates a perspective view of the lamp cup according to the present invention.

FIG. 6 illustrates a perspective view of a wide-angle LED bulb according to the present invention.

### DETAILED DESCRIPTION

For convenient illustrating the embodiment, hereinafter, the direction of “backward”, “forward”, and “upward”, or “downward” are named with respect to an installed LED bulb. It is thus the terms “backward” and “upward” Indicated the direction is toward the ceiling and “forward” or “downward” Indicated the direction is toward the floor.

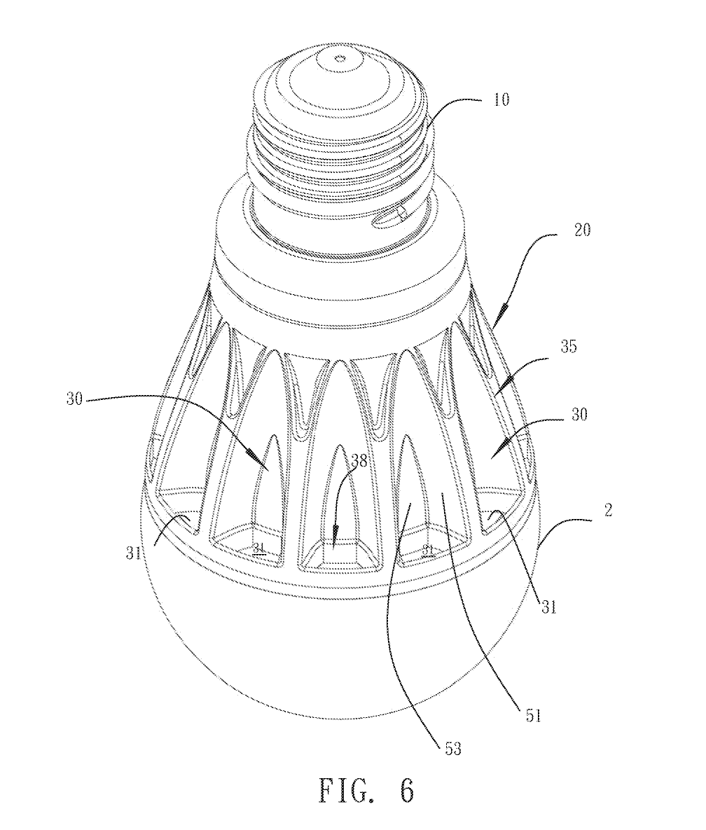

The present invention discloses a wide-angle LED bulb, in particularly relates to a LED bulb having one planar LED substrate only rather than assembled two or three LED substrate in different directions such as three-dimensional modeling as the prior art but can produce similar effect as an omnidirection LED bulb. Herein the LED bulb according to the present invention is called as a wide-angle LED bulb since the backward light beam is over two folds than that of LED bulb without any aperture. It is due to the LED lamp cup has several apertures formed therethrough so that a secondary portion of light beam can through them emitting backward light and a main portion of light emitting forward through the cover. Furthermore, brightness, uniformity, and beam illuminating range backward can be adjusted by modified the inclined angles of the apertures and the sizes and/or the reflectivity of the lamp cup 20 and the curvatures of the sidewalls of the cabin-shaped recess 30, please see FIG. 6.

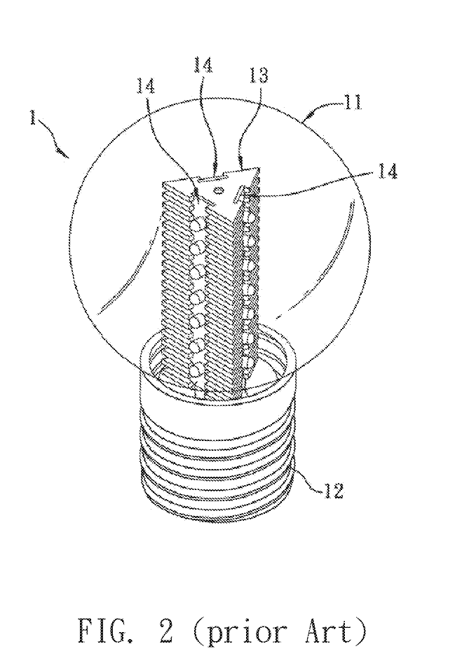

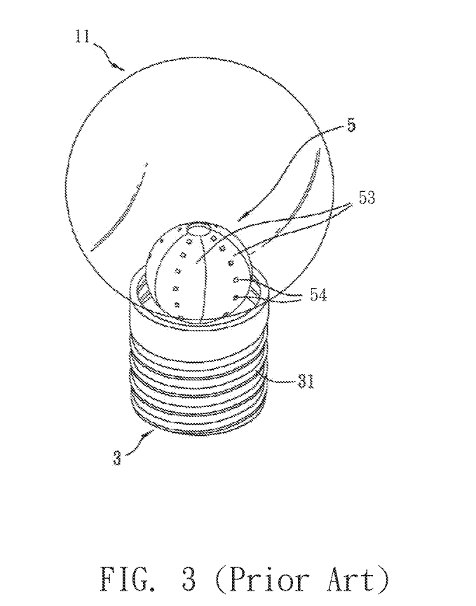

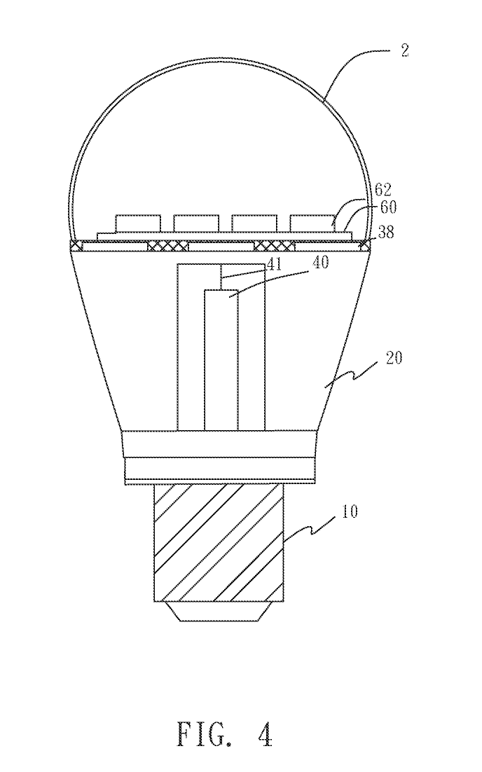

Referring to FIG. 4, the schematic diagram depicts a wide-angle LED bulb in accordance with the present invention. It includes a lamp cup 20, a LED submount having LED chips 62 mounted on a circuitry of a substrate 60, a half global cover 2 rather than global shape as prior art, a lamp head 10, a LED driver component 40, and electrical wires 41. The LED pedestal has one planar substrate 60 rather than assembled two or three LED substrates in three direction as the first embodiment of the prior art, as shown in FIG. 2 or a three-dimension sphere modeling as the second embodiment of the prior art, as shown in FIG. 3. The position of the LED substrate is lower than the position of the apertures 38. The LED substrate 60 is located in the cover 2. The main portion of downward LED light will through the cover 2 out but a portion of it between about 10% of light scattered upward through the apertures 38 out after several reflective and scattered processes by the lamp cup 20 and the diffused powders, which are doped in the material of the cover 2.

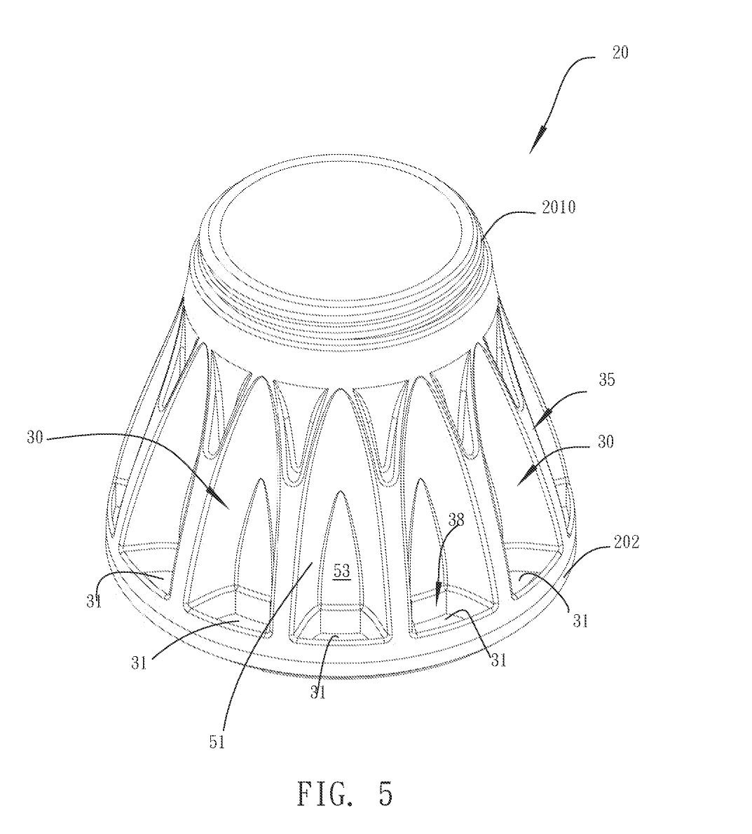

Referring to FIG. 5, it depicts a perspective view of the lamp cup 20. The upper edge of the lamp cup 20 has a thread 2010 to screw with the lamp head 10. The alternative current (AC) power though the lamp head 10 inputs to the LED driver component 40. The LED driver component 40 then provides the rectifier electric DC power to the LED chips 62 through the electrical wires 41, as shown in FIG. 4.

Still referring to FIG. 5, the lamp cup 20 is modeled with a plurality of cabin-shaped recesses 30 around the circumference of the lamp cup 20. The convex ridge 35 is formed in between two recesses 30. The apertures 38 are thus hided and located at the seat portions which are horizontal portions of the cabin-shaped recesses 30. A plurality of transparent or colorful sheets 31 may optionally past over the apertures 38, respectively, to prevent moisture or dust dropping therefrom into the bulb and isolate the LED module from contact with water and avoid dropped dust degrading transmittance of the half global cover 2. The other function of the lamp cup 20 modeled with a plurality of cabin-shaped recesses 30 is to increase the areas of the heat sink.

Please refer to FIG. 6. It is a perspective view of the LED bulb. The half global cover 2 is mounted on the lamp cup 20 through the engaging ring 202.

The secondary portion of the emitting light through the apertures 38 backward to the ceiling, a direction along the connection line between the lamp head 10 and the apex of the half global cover 20.

The main portion of the emitting light is out through the half global cover 20. Since the emitting light includes the main portion downward and the minor portion upward, thereby the beam angle is found over 90°. The beam angle 90° is equal to a LED angle 180°. The experimental report from the device according to the present invention is shown in Table 1, which is shown in the following paragraph:

TABLE 1

| | Cup | Total aperture | Total aperture |
|---|---|---|---|
| | without any | areas | areas |
| Bulb | aperture | 1.5 cm² | 6.7 cm² |
| Total lumens (ln) | 1239.95 | 1286.01 | 1321.60 |
| Beam angle of 0° | 125.93° | 134.11° | 135.78° |
| Beam angle >135° | 1.0% | 1.7% | 1.9% |
| Beam angle >90° | 5.9% | 9.9% | 10.2% |

The results shown the beam angle backward, the brightness and beam sizes can be adjusted by modified the inclined angles and total opening area of the apertures with high reflectivity of the lamp cup 20. To increase the reflectivity, the color of the lamp cup 20 is preferred to be white or other light colors. Furthermore, the total lumens increase with the aperture area. The curvatures of the curved surface of the cabin-shaped recess 30 can also be utilized to modify the illuminating range and the brightness. The sidewall of the cabin-shaped recess 30 is consisting of two surfaces, a main curved surface 51 and a sub-curved surface 53. The sub-curved surface 53 is the small one surrounded by the main curved surfaces 51. In a preferred embodiment, the inclined angle of the aperture is set between about 0°˜75° measured from the optical axis, e.g. if the sub-curved surface 53 is along a vertical direction, the inclined angle is of 0° and if the sub-curved surface 53 is inclined, the angle increased.

The present invention has the following benefits:

(1) In comparison with the prior arts using two or three LED boards or 3-D modeling board, the wide-angle LED bulb has one planar LED board only according to the present invention. The wide-angle LED bulb provides a similar effect as an omnidirectional LED bulb. Thus it can cost down an omnidirectional LED bulb.

(2) With the areas of the aperture increase, the portion of backward light increases.

(3) The backward light scattered by diffused powders on the bulb cover and the lamp cup is occupied between about 1.7˜2% of total lumens of LED light for a beam angle larger than 135 or between about 9.9%˜10.2% for a beam angle larger than 90° comparing to 1% and 5.9%, respectively, for a lamp cup without an aperture.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A lamp cup for housing the LED pedestal having one LED submount thereon and the LED driver component, characterized in that: said lamp cup is modeled with a plurality of cabin-shaped recesses formed around a circumference of said lamp cup and spaced each other by a convex ridge and each of said cabin-shaped recesses has an aperture formed therein and said aperture is formed for backward light pass through.

2. The lamp cup according to the claim 1 wherein said aperture is located at horizontal portion of said cabin-shaped recess.

3. The lamp cup according to the claim 1 wherein said lamp cup has a white or light color.

4. A wide-angle light emitting diode (LED) bulb comprising:
a LED pedestal having one LED submount thereon;
a LED driver component electrically connected to the electrodes of the LED submount,
a lamp cup for housing the LED pedestal and the LED driver component, said lamp cup having a plurality of apertures distributed around a circumference of said lamp cup formed therein so that a portion of scattered backward light by said emitting by said LED submount can through said apertures out;
a bulb cover engaging with an edging of a first ending of said lamp cup for main portion of LED light through it out;
a lamp head engaging with an edging of a second ending of said lamp cup for screwing with a socket;
wherein said backward light is a scattered LED light scattered by said bulb cover associated with said lamp cup.

5. The wide-angle LED bulb according to claim 4 furthering comprising a plurality of transparent or colorful sheets pasted on each of said apertures, respectively.

6. The wide-angle LED bulb according to dam 4 wherein said bulb cover is a half global cover.

7. The wide-angle LED bulb according to claim 4 wherein said lamp cup is modeled with a plurality of cabin-shaped recesses formed therein around a circumference and spaced each other by a convex ridge.

8. The wide-angle LED bulb according to claim 4 wherein said apertures are located each at a horizontal portion of said cabin-shaped recesses.

9. The wide-angle LED bulb according to claim 4 wherein said lamp cup has a white or light color.

10. The wide-angle LED bulb according to claim 4 wherein said apertures have an inclined angle between about 0°˜75°.

11. The wide-angle LED bulb according to claim 4 wherein said bulb cover is doped with diffused powders so that a portion of forward light is scatted by said diffused powders to become sources of said backward light.

12. The wide-angle LED bulb according to claim 4 wherein said backward light is occupied between about 1.7˜2% of total lumens of LED light for a beam angle larger than 135° or between about 9.9%-10.2% for a beam angle larger than 90°.

13. A wide-angle light emitting diode (LED) bulb comprising:
a LED planar pedestal having one LED submount thereon;
a LED driver component electrically connected to the electrodes of the LED submount;
a lamp cup for housing the LED pedestal and the LED driver component, said lamp cup modeled with a plurality of cabin-shaped recesses formed around a circumference surface spaced each other by a convex ridge thereof;
a half global cover engaging with an edging of a first ending of said lamp cup; and
a lamp head engaging with an edging of a second ending of said lamp cup for screwing with a socket;
wherein said backward light is a scattered LED light scattered by said bulb cover associated with said lamp cup.

14. The wide-angle LED bulb according to claim 13 wherein said half global shaped cover is doped with diffused powders so that a portion of forward light is scatted by said diffused powders to become sources of said backward light.

15. The wide-angle LED bulb according to claim 13 furthering comprising a plurality of transparent or colorful sheets pasted on each of said apertures, respectively.

16. The wide-angle LED bulb according to claim 13 wherein said lamp cup has a white or light color.
